(19) United States
(12) Patent Application Publication
(10) Pub. No.: US 2012/0232827 A1
(43) Pub. Date: Sep. 13, 2012

(54) ELECTRIC CONNECTOR AND TEST DEVICE USING THE SAME

(75) Inventor: TIEN-TSAI HSU, HSINCHU (TW)

(73) Assignee: HMD BIOMEDICAL INC., HSINCHU COUNTY (TW)

(21) Appl. No.: 13/413,929

(22) Filed: Mar. 7, 2012

(30) Foreign Application Priority Data
Mar. 11, 2011 (TW) 100108297

(51) Int. Cl. G06F 19/00; H01R 43/04; H01R 12/00

(52) U.S. Cl. 702/122; 439/78; 29/882

(57) ABSTRACT

An electric connector and a test device using the same, said electric connector includes an electric circuit board and a plurality of conduction terminals. Said electric circuit board is provided with a plurality of connection terminals arranged into an array. Said plurality of conduction terminals are located on said electric circuit board corresponding respectively to each of said connection terminals. Each conduction terminal includes a base, a connection portion, and a contact portion. Said connection portion extends along bottom of said base to form into shape, and is connected with said connection terminal of said electric circuit board; and said contact portion extends along a side of said base, slanting upward and bending into shape. Said electric connector is used in said test device, for a test strip to insert in, to measure a whole set of signals of said test strip at the same time.

### BACKGROUND OF THE INVENTION

1. Field of the Invention

The present invention relates to an electric connector and a test device using the same, and in particular to an electric connector utilized in a test device, that is capable of measuring the whole set signals of a test strip simultaneously.

2. Description of the Related Art

With the rapid progress and development of medical science, various test strips and test devices have been developed, to measure material concentrations in a biological fluid, to facilitate conducting measurement in hospitals, clinics, or households at any time, and to observe and record real-time the health conditions of a patient for the reference of medical personnel to diagnose and cure a patient. In general, test strips may have defects and faults incurred during manufacturing process due to time or environment factors, thus affecting its characteristics and performances. For this reason, usually, test strips are manufactured by batches. During manufacturing, each batch of test strips is assigned a specific lot number by the manufacturer, to facilitate recording and tracing information of that batch of test strips. The lot number can be used by the test device to calibrate the test strips, to obtain more accurate measurement data.

In this respect, refer to Taiwan Patent Application No. 96100251. Wherein, the test strip disclosed is provided with a plurality of identification electrodes in an identification electrode region, so that a portion of the identification electrodes can be processed into an open-circuit based on different parameters, to provide various identification signals. However, in case the number of identification electrodes is limited, then the identification signals they provide may not be sufficient to distinguish among a plurality of customers, test devices, or test strips. Moreover, to dispose a plurality of identification electrodes on a test strip of fixed size, the number and size of identification electrodes are certain to be limited, such that the lot numbers and information density it can provide to the test device are rather limited. In addition, the connector of the test device does not have connection points to connect large amount of electrodes. Also, the electric connector has the problem of being not easy to manufacture, and it is rather difficult to produce large number of metal connection points on an outer shell or in an insertion slot.

Therefore, presently, the design and performance of an electric connector and a test device using the same are not quite satisfactory, and it has much room for improvement.

### SUMMARY OF THE INVENTION

In view of the problems and drawbacks of the prior art, the present invention provides an electric connector and test device using the same to overcome effectively the shortcomings of the prior art.

A major objective of the present invention is to provide an electric connector and a test device using the same, wherein, the electric connector is simple in construction, and easy to design and produce. In addition, it is low in production cost, and can be installed easily in a test device. Moreover, it is capable of testing large number of signals coming from test strips at the same time.

In order to achieve the above-mentioned objective, the present invention provide an electric connector, that can be applied in a test device using the same. The electric connector includes an electric circuit board and a plurality of conduction terminals. The electric circuit board is provided with a plurality of connection terminals arranged into an array. The plurality of conduction terminals are located on the electric circuit board corresponding respectively to each of the connection terminals. Wherein, each conduction terminal includes a base, located on the electric circuit board; a connection portion, extending along bottom of the base to form into shape, and is connected with the connection terminal of the electric circuit board; and a contact portion, extending along a side of the base, slanting upward and bending into shape.

The present invention further provides a test device utilizing the electric connector, including a body, and an electric connector. The body includes at least a micro-processor unit, used to process signals and output a test signal. The electric connector is provided inside the body, and is connected to the micro-processor unit, for a test strip to insert in to measure the whole set of signals of the test strip. The electric connector includes an electric circuit board and a plurality of conduction terminals. The electric circuit board is provided with a plurality of connection terminals. The plurality of conduction terminals are located on the electric circuit board, and each corresponds and is connected to each connection terminal. Wherein, each conduction terminal includes a base, located on the electric circuit board; a connection portion, extending along bottom of the base to form into shape, and is connected to the connection terminal of the electric circuit board; and a contact portion, extending along a side of the base, slanting upward and bending into shape.

The present invention also provides a method of manufacturing an electric connector, that can be used in a test device, comprising the following steps: (A) arranging and connecting a plurality of conduction terminals onto at least a folding material belt, one end of base of each conduction terminal is connected vertically to the folding material belt, with the other end of the base extending upward, slanting and bending to form a contact portion, the bottom of the base extends vertically downward to form a connection portion; (B) installing and fixing the folding material belt and the conduction terminals onto a fixture, the base and contact portion are closely adjacent to the installation surface of the fixture, the connection portion are of an upward vertical shape relative to the installation surface; (C) placing the electric circuit board having a plurality of terminal holes arranged into an array onto the corresponding fixture, the terminal holes are for inserting and bonding the connection portion of each conduction terminal; and (D) taking out the electric circuit board, the plurality of conduction terminals, and the folding material belt from the fixture, and detach the folding material belt, so that the conduction terminals are arranged into an array on the electric circuit board.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of an electric connector according to the present invention;

FIG. 2 is an exploded view of electric connector according to the present invention;

FIGS. 3(A) and 3(B) are schematic diagrams of placing an electric connector into a test device according to the present invention;

FIG. 4 is a cross section view along A-A′ line of FIG. 3(B);

FIGS. 5(A) to 5(G) are schematic diagrams of parts of an electric connector corresponding to its steps of manufacturing according to the present invention;

FIG. 6 is a schematic diagram of structure of a test device utilizing an array type electric connector according to the present invention;

FIG. 7 is a block diagram of a test device utilizing an array type electric connector according to the present invention; and

FIGS. 8(A) to 8(D) are schematic diagrams of a plurality of connection terminals of an electric connector in a 2-dimensional arrangement.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

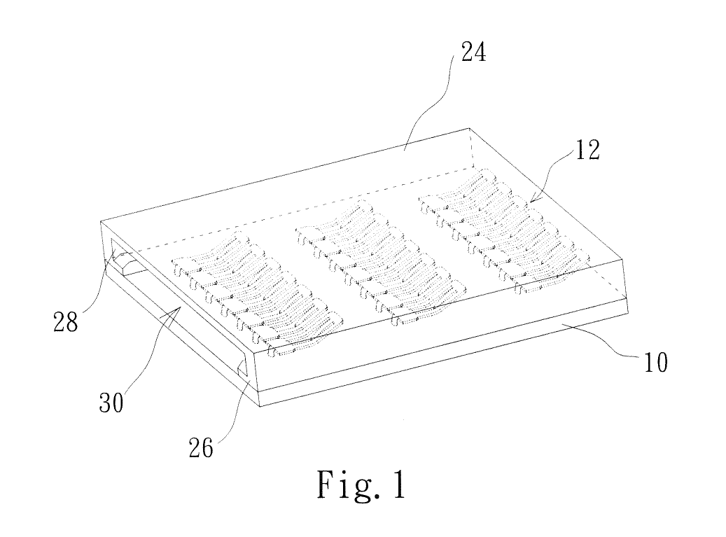

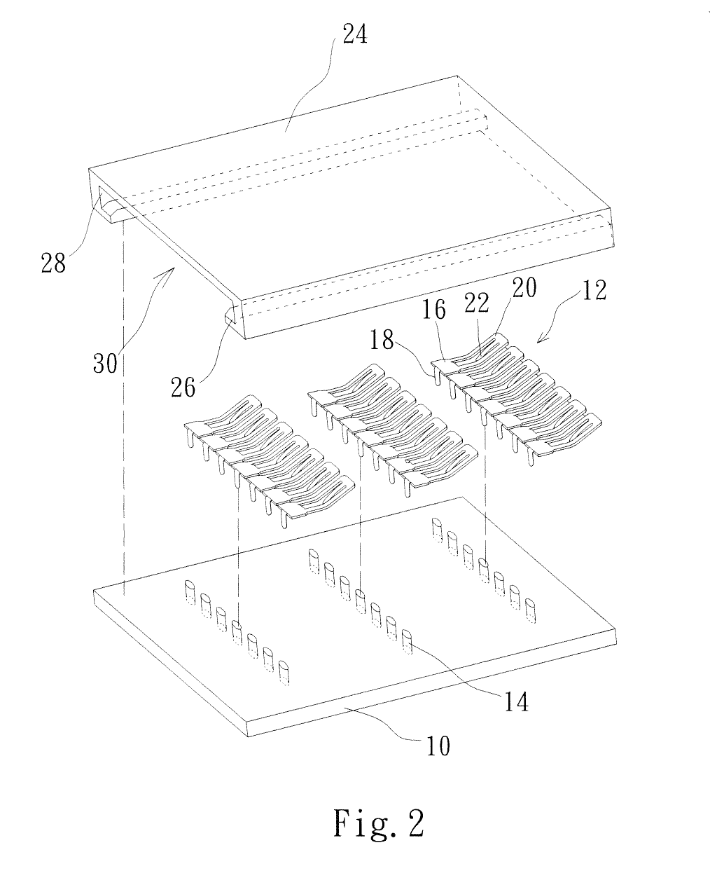

Refer to FIGS. 1 & 2 at the same time. FIG. 1 is a schematic diagram of an electric connector according to the present invention; and FIG. 2 is an exploded view of electric connector according to the present invention. As shown in FIGS. 1 and 2, the electric connector includes an electric circuit board 10 and a plurality of conduction terminals 12. The electric circuit board 10 is provided with a plurality of connection terminals 14, that are arranged equal-spaced into a 2-dimensional array on the electric circuit board 10. Each of the plurality of conduction terminals 12 on the electric circuit board 10 corresponds respectively to each of the connection terminals 14. Since the plurality of connection terminals 14 are arranged into an array, so the plurality of conduction terminals 12 are also arranged into an array, to correspond to the respective connection terminals 14, wherein, the connection terminals 14 can be terminal holes or connection pads (not shown). The conduction terminal 12 includes a base 16, a connection portion 18, and a contact portion 20. Wherein, the based 16 is located on the electric circuit board 10, the connection portion 18 extends along the bottom of the base 16 vertically downward to form into shape, and is inserted and bonded into the terminal holes through using a Pin Through Hole technology; or the connection portion 18 extends horizontally along the bottom of the base 16 to form into shape (not shown), and is bonded to the connection pad through utilizing a Surface Mount Technology. The contact portion 20 extends along a side of the base 16, slanting upward and bending into shape. In the middle of the contact portion 20 is extended an auxiliary piece 22, so that the whole contact portion 20 is of an inverted [symbol] E [symbol] and is made of spring piece or conductive rubber.

The electric connector further includes a first cover 24, disposed over the electric circuit board 10 and the conduction terminals 12. Wherein, the bottom portions on both sides of the first cover 24 are extended inward respectively an extension portion 26, and is over the electric circuit board 10. Wherein, a [symbol] [symbol] [symbol] shape indent slot 28 is formed between the extension portion 26 and top end inside the first cover 24. The conduction terminals 12 are disposed between the first cover 24 and the electric circuit board 10. Since the contact portion 20 of the conduction terminal 12 extends along a side of base 16, slanting upward and bending into shape, therefore, the end of contact portion 20 is slightly higher than the thickness of the extension portion 26. The front end of the first cover 24 is an open slot 30, for the test strip to insert in, and that will be explained in detail later.

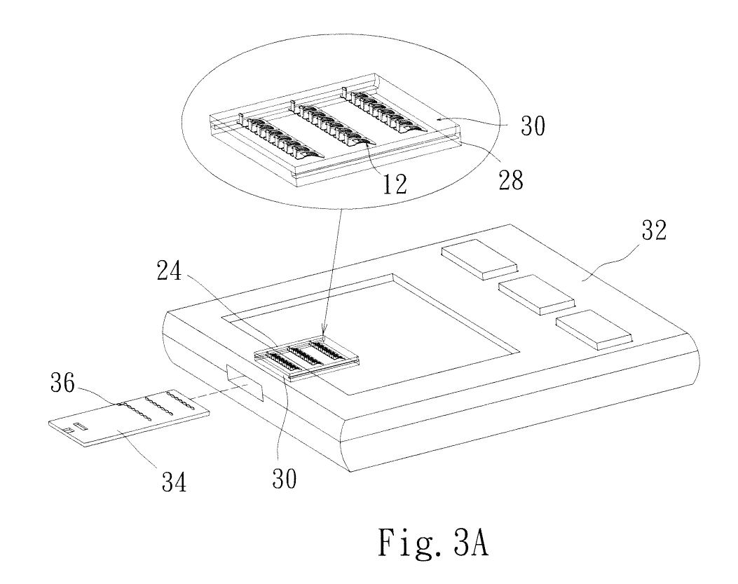

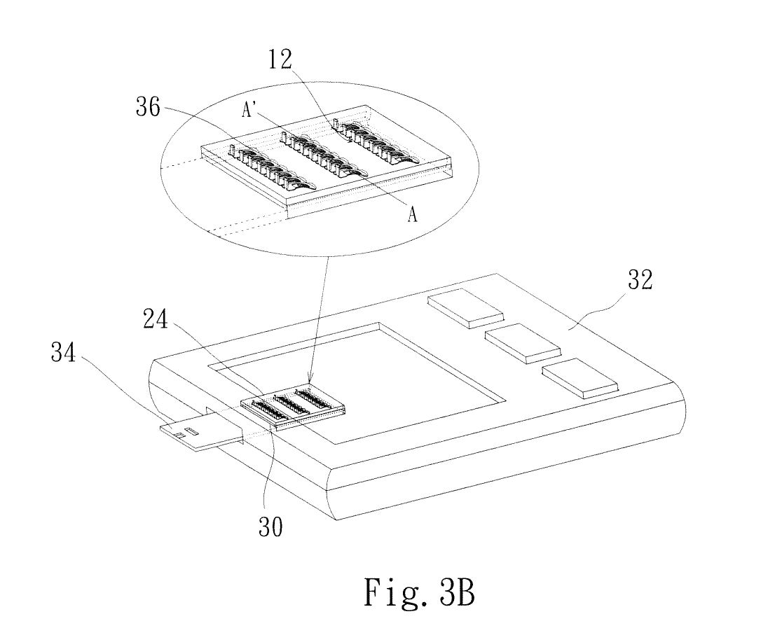

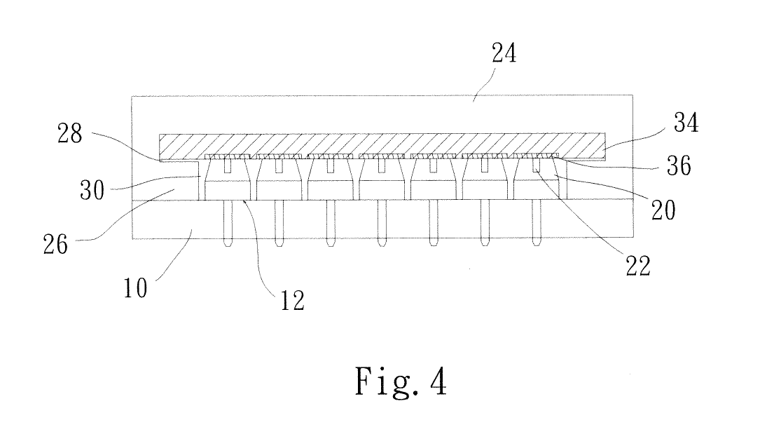

Refer to FIGS. 3(A), 3(B), and 4 simultaneously. FIGS. 3(A) and 3(B) are schematic diagrams of placing an electric connector into a test device according to the present invention; and FIG. 4 is a cross section view along A-A′ line of FIG. 3(B). As shown in FIGS. 3(A), 3(B), and 4, the electric circuit board 10 having the first cover 24 installed, and the conduction terminals 12 can be put inside the test device 32, and the open slot 30 of the first cover 24 is closed tightly against the outer side of the test device 32. Wherein, the size of the open slot 30 can be designed according to actual requirement, to receive the insertion slot of the test strip 34, and the thickness of the test strip 34 is slightly less than the height of the indent slot 28. The test strip 34 can be an electric-chemical test strip, an optical test strip, or an immunity test strip.

When a user inserts the test strip 34 into the open slot 30, and pushes it along the indent slot 28 to reach and fix inside, since the contact portion 20 of the conduction terminal 12 is higher than the thickness of the extension portion 26, so the contact portion 20 is pressed by the test strip 34, to contact directly the corresponding conduction point. Herein, the electric circuit board 10 having conduction terminals 12 arranged equal-spaced into an array is taken as example for explanation.

In order to apply in cooperation, the electrode region 36 of the test strip 34 is designed into a plurality of conduction points arranged equal-spaced into an array. Therefore, when the electrode region 36 is pushed toward the contact portion 20 of the respective conduction terminal 12, an effective contact force is produced through the elastic characteristic of the contact portion 20, so that the contact portions 20 of the conduction terminals 12 are in contact with the respective conduction points, to form an electrical connection. As such, the test device is able to measure the plurality of conduction points arranged into an array simultaneously, to obtain the whole set of signals of the test strip 34. When the test strip 34 is taken out from the electric connector, the auxiliary piece 22 of the conduction terminals 12 provides a forward force, to make the contact portion 20 quickly restore to its original position.

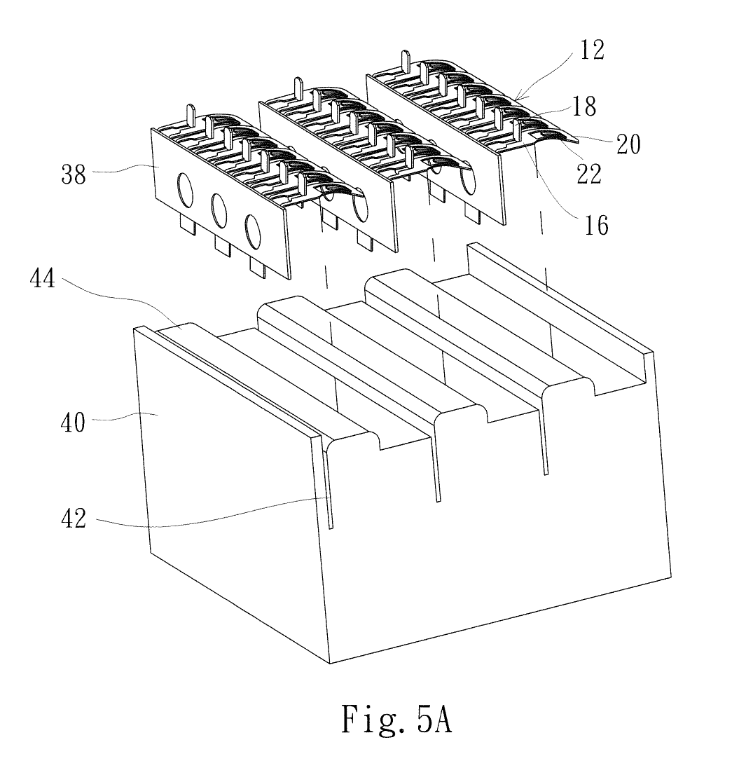

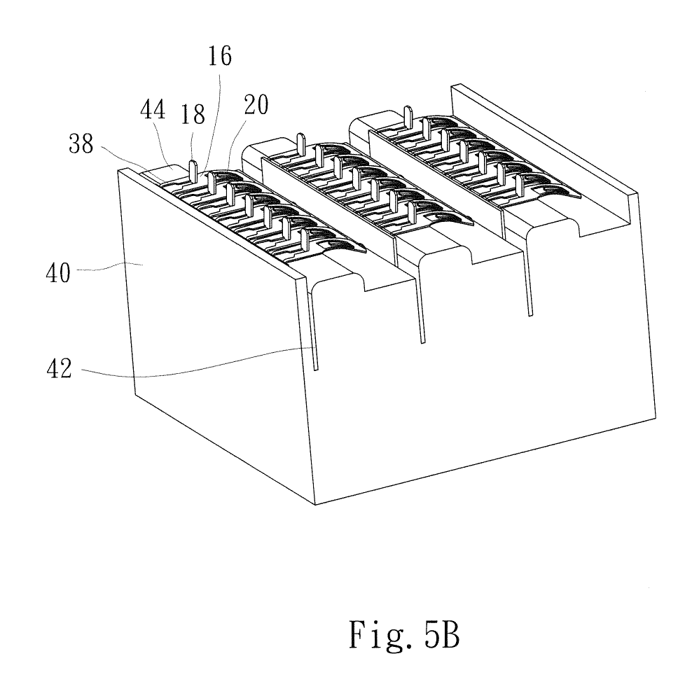

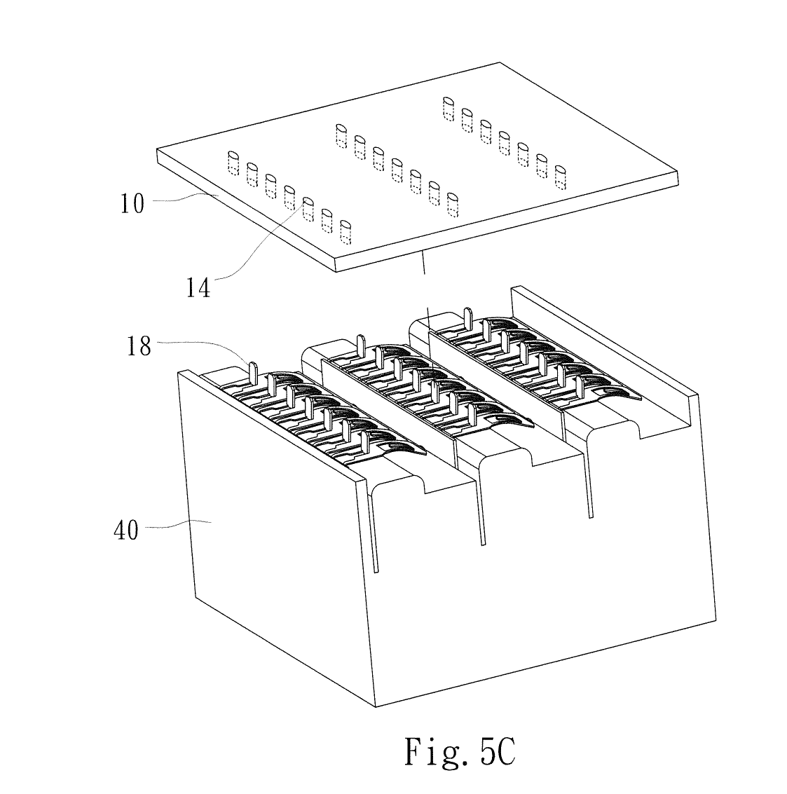

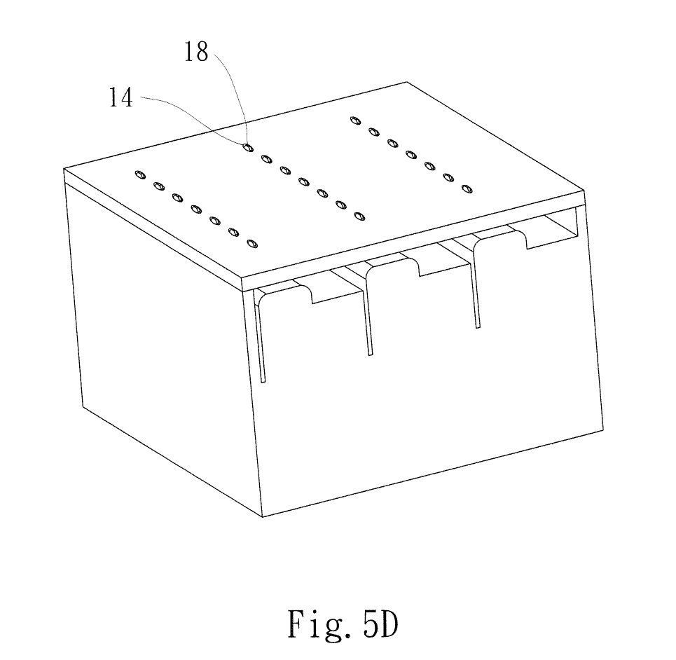

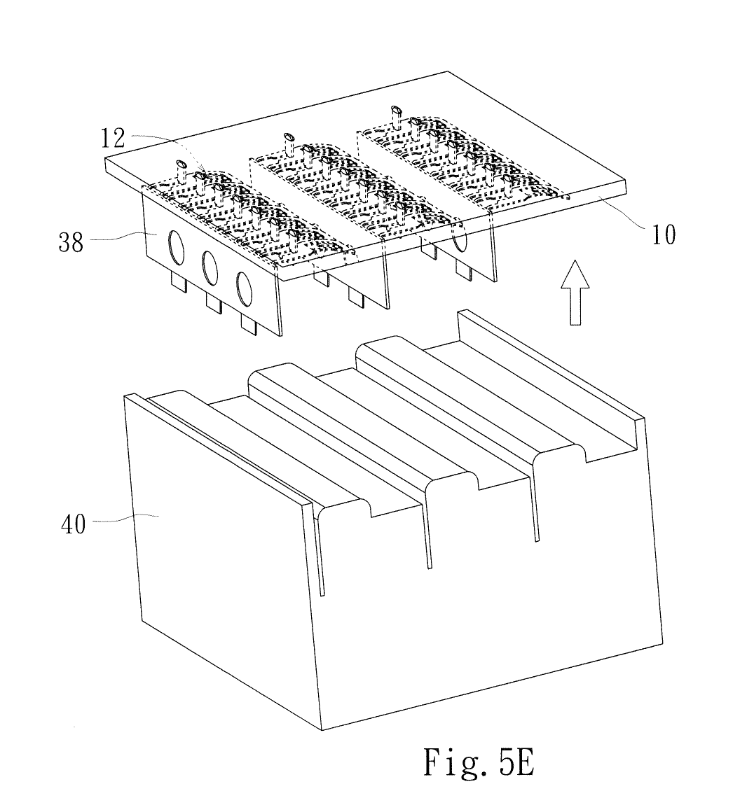

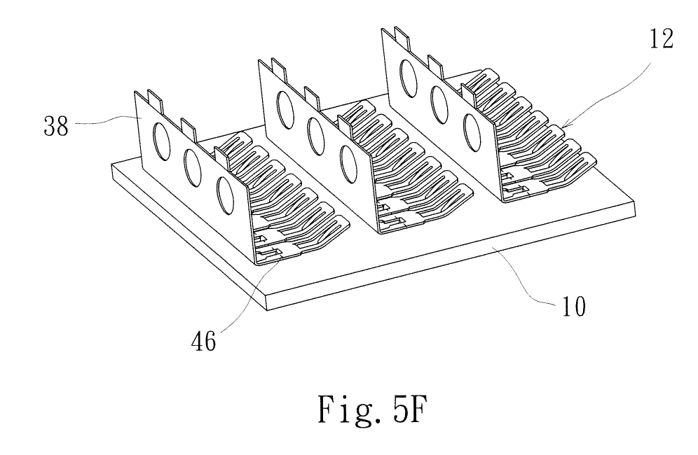

The electric connector of the present invention is simple in construction, easy to design and produce. It is not only low in production cost, but it is also easy to install into the test device 32, so that it can be used in cooperation with array type test strip 34 in realizing the medical test required. Refer to FIGS. 5(A) to 5(G) simultaneously for schematic diagrams of various parts of an electric connector corresponding to its steps of manufacturing according to the present invention. Herein, the Pin Through Hole technology is taken as an example for explanation. Firstly, as shown in FIG. 5(A), arranging a plurality of conduction terminals 12 with equal spacing onto at least a folding material belt 38. Herein, three sets of folding material belts 38 each having a plurality of conduction terminals 12 are taken as an example for explanation. The conduction terminal 12 includes a base 16, a connection portion 18, and a contact portion 20. One end of the base 16 is connected vertically to the folding material belt 38. The contact portion 20 extends along the other end of the base 16 upward, slanting and bending into shape. The connection portion 18 extends along bottom of the base 16 vertically downward to form into shape. Wherein, the folding material belt 38 and the conduction terminals 12 form integrally into a body. Then, fix the folding material belt 38 having the conduction terminals 12 onto a fixture 40. The fixture 40 includes equal-spaced installation slots 42 and installation surfaces 44. The shape of the installation surface 44 corresponds to the shape of the conduction terminals 12. As shown in FIG. 5(B), when the folding material belt 38 is disposed in the corresponding installation slot 42, the base 16 and contact portion 20 are closely adjacent to the installation surface 44 of the fixture 40, and the connection portion 18 are of a vertical upward shape relative to the installation surface 44.

Subsequently, as shown in FIG. 5(C), disposing an electric circuit board 10 onto the corresponding fixture 40. The electric circuit board 10 is provided with a plurality of terminal holes arranged equal-spaced into an array, for insertion of the connection portions 18 of the corresponding conduction terminals 12. Then, as shown in FIG. 5(D), utilizing a conductive material, such as tin paste, to weld and fix the connection portions 18 onto the terminal holes, hereby fixing the conduction terminals 12 entirely onto the electric circuit board 10.

Then, as shown in FIG. 5(E), taking out the electric circuit board 10 having a plurality of conduction terminals 12 and folding material belt 38 fixed thereon from the fixture 40. Subsequently, as shown in FIG. 5(F), pressing and bending along the dotted line 46 between the folding material belt 38 and base 16 of the conduction terminals 12, to detach the folding material belt 38 from the electric circuit board 10. Finally, as shown in FIG. 5(G), completing the production of electric connector of the present invention, with the conduction terminals 12 arranged equal-spaced into an array on the electric circuit board 10. In addition to the Pin Through Hole technology, the Surface Mount Technology can also be used to make the electric connector, through direct bonding and gluing by using tin paste.

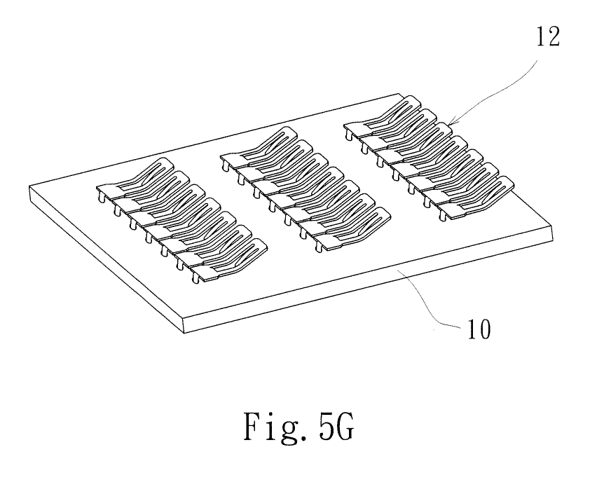

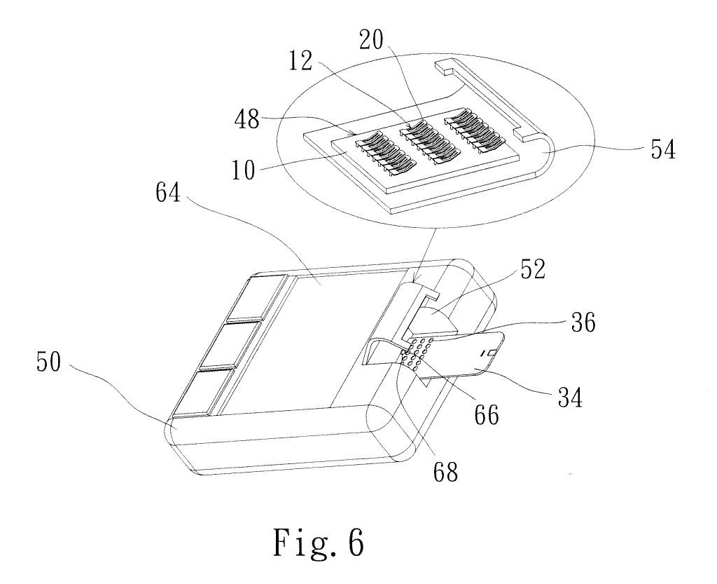

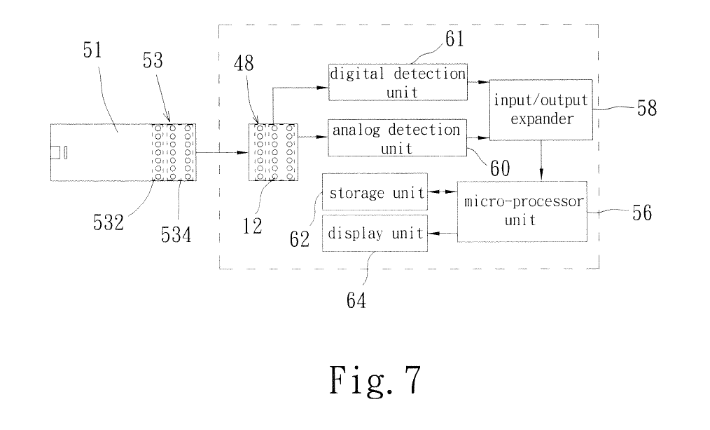

As mentioned above, the electric connector can be put inside the test device, in addition to the insertion connection approach of test strip, a flip cover connection approach can also be used. Since the present invention has much more conduction points, and the insertion connection approach is liable to cause parallel friction contact, so that the quality of electrical contact can be adversely affected by the unevenness of the test strip or frequently use times. In contrast, in the flip cover approach, vertical placement contact is used to improve the problem of improper contact of the conduction point. In this respect, refer to FIGS. 6 and 7 respectively for a schematic diagram of a structure of test device utilizing an array type electric connector according to the present invention; and a block diagram of a test device utilizing an array type electric connector according to the present invention. As shown in FIGS. 6 and 7, the test device includes an array type electric connector 48, and a body 50. The array type electric connector 48 is used for electric connection of an array type test strip 51, to detect the test signals, and that will be explained in detail as follows.

The array type electric connector 48 includes an electric circuit board 10 and a plurality of conduction terminals 12. In the present embodiment, the structure of the plurality of conduction terminals 12, and the way they are arranged on the electric circuit board 10 are the same as that of the previous embodiment, as shown in FIGS. 5(A) to 5(G), so they will not be repeated here for brevity. In the present embodiment, the body 50 further includes a containing groove 52, a second cover 54, a micro-processor unit 56, an analog detection unit 60, a digital detection unit 61, an input/output expander (I/O expander) 58, a storage unit 62, and a display unit 64. Wherein, the analog detection unit 60 is connected to the conduction terminals 12 to generate analog signals; the digital detection unit 61 is connected to the conduction terminals 12 to generate digital signals; the input/output expander 58 is used to expand the number of pins of micro-processor unit 56; the storage unit 62 is used to store test data; the display unit 64 is used to display test data; and the micro-processor unit 56 is electrically connected to the analog detection unit 60, the digital detection unit 61, the input/output expander (I/O expander) 58, the storage unit 62, and the display unit 64, such that the micro-processor unit 56 is used to process the analog signals and digital signals and output the test data. The array type electric connector 48 can be disposed inside the second cover 54 or in a containing groove 52 (not shown), and the array type electric connector 48 is connected electrically to the micro-processor unit 56. The containing groove 52 is disposed in a position corresponding to that of the second cover 54, for containing the array type test strip 34. In order to strengthen fixing the array type test strip 51 in the containing groove 52, a fixing piece 66, such as a protrusion block can be placed on the containing groove 52. The array type test strip 51 is provided with an opening 68 which may be replaced with a groove or a notch, and is located on the corresponding fixing piece 66.

When the array type electrode region 53 of the array type test strip 51 is fixed onto the containing groove 52, wherein, the array type electrode region 53 further includes an analog signal region 532 and a digital signal region 534, the second cover 54 can be put and covered on the corresponding containing groove 52. The conduction terminals 12 of the array type electric connector 48 below the second cover 54 correspond to the respective conduction points arranged equal-spaced into an array on an array type electrode region 53, and are in direct contact with the corresponding conduction points through contact portion 20 of the respective conduction terminals 12, hereby achieving an electric connection.

The analog detection unit 60 is used to detect an analog signal region 532 of the array type test strip 51, while the digital detection unit 61 is used to detect a digital signal region 534 of the array type test strip 51, to generate analog signal and digital signal simultaneously, and then transmit them to the micro-processor unit 56. Wherein, any of the conduction points in the array type electrode region 53 of the array type test strip 51 can serve as an activation point. Upon connecting electrically the activation point to one of the conduction terminals 12 of the array type electric connector 48, a digital signal or an analog signal is generated. Then, the micro-processor unit 56 determines if the insertion of test strip 51 is correct and successful, thus reminding user to insert the test strip again if necessary, and preventing incorrect determination of signals. Subsequently, the micro-processor unit 56 performs parameter determination and setting based on the digital signal, the analog signal, and the test strip related parameters stored in the storage unit 62, and performs testing and analysis of the material in the test sample on the array type test strip 51, and transmits the test data to the display unit 64. In addition, an input/output expander 58 is provided between the array type electric connector 48 and the micro-processor unit 56, to meet the requirement for the plurality of conduction terminals 12 arranged into an array in the array type electric connector 48, so that the micro-processor unit 56 has sufficient number of pins to receive digital signals and analog signals from the plurality of conduction terminals 12. Finally, upon finishing testing, all it has to do is to open and lift the second cover 54, and take out the array type test strip 51, in achieving the objective of a flip cover test device.

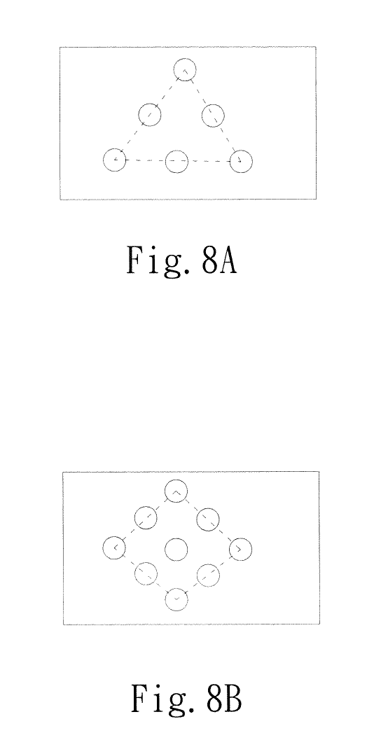

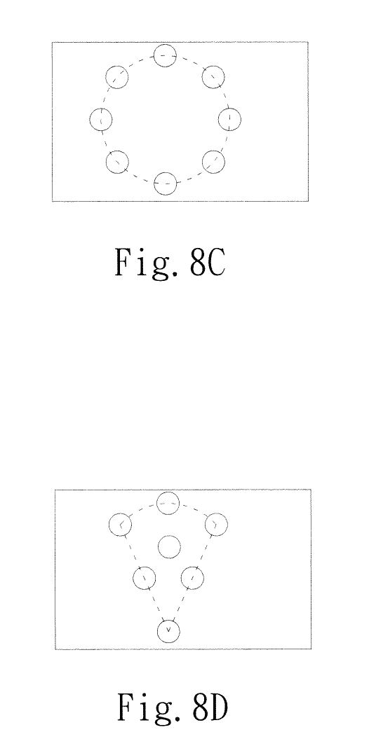

Furthermore, in addition to arranging the connection terminals of the electric circuit board equal-spaced into a 2-dimensional array, the connection terminals can be designed into various forms of 2-dimensional arrangement. As shown in FIG. 8(A), the connection terminals are in a triangular arrangement, with a space existing between two adjacent connection terminals. As shown in FIG. 8(B), the connection terminals are in a rhomb arrangement, with a space existing between two adjacent connection terminals. As shown in FIG. 8(C), the connection terminals are in circular arrangement, with a space existing between two adjacent connection terminals. As shown in FIG. 8(D), the connection terminals are in sector arrangement, with a space existing between two adjacent connection terminals. In the present invention, only a few embodiments about connection terminals on the electric circuit board are described. However, in actual applications, the present invention is not limited to any specific 2-dimensional arrangement, such that it may include polygon, circular, ellipse, sector, or bow shape. Wherein, the polygon may further include triangle, rectangle, parallelogram, trapezoid, rhomb, pentagon, or hexagon. As such, the present invention is not only capable of processing large amount test signals, but it can also be used for test strips of various design requirements, thus having a good competitive edge in the market.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An electric connector, used in a test device, comprising:
an electric circuit board, provided with a plurality of connection terminals arranged into an array; and
a plurality of conduction terminals, disposed on said electric circuit board, each said conduction terminal is connected respectively to each said corresponding connection terminal, and each said conduction terminal includes:
a base, provided on said electric circuit board;
a connection portion, extending along bottom of said base to form into shape, and is connected to said connection terminal of said electric circuit board; and
a contact portion, extending along a side of said base, slanting upward and bending into shape.

2. The electric connector as claimed in claim 1, wherein said connection terminals are terminal holes.

3. The electric connector as claimed in claim 2, wherein said connection portion extends along bottom of said base vertically downward into shape for inserting into said terminal hole.

4. The electric connector as claimed in claim 1, wherein said connection portion extends horizontally along bottom of said base to form into shape, and is connected to said connection terminal.

5. The electric connector as claimed in claim 1, wherein an auxiliary piece is extended from middle of said contact portion, and said contact portion is made of a spring piece or conductive rubber.

6. The electric connector as claimed in claim 1, wherein said connection terminals are arranged into various arrays including a polygon array, a circular array, an elliptical array, a sector array, or a bow shape array of 2-dimensional arrangement, and a space exists between adjacent connection terminals.

7. The electric connector as claimed in claim 6, wherein said polygon array includes a triangle array, a rectangle array, a parallelogram array, a trapezoid array, a rhomb array, a pentagon array, or a hexagon array of 2-dimensional arrangement.

8. The electric connector as claimed in claim 1, further comprising:
a first cover, installed over said electric circuit board and said conduction terminals.

9. A test device utilizing an electric connector, comprising:
a body, includes at least a micro-processor unit, to process signals and output a test data; and
an electric connector, disposed inside said body for a test strip to insert in, and is connected to said micro-processor unit, said electric connector includes:
an electric circuit board, provided with a plurality of connection terminals arranged into an array; and
a plurality of conduction terminals, disposed on said electric circuit board, each said conduction terminal is connected respectively to each said corresponding connection terminal, each said conduction terminal includes:
a base, provided on said electric circuit board;
a connection portion, extending along bottom of said base to form into shape, and is connected to said connection terminal of said electric circuit board; and
a contact portion, extending along a side of said base, slanting upward and bending into shape.

10. The test device utilizing an electric connector as claimed in claim 9, wherein said body further comprising:
an analog detection unit, connected to said conduction terminal to produce an analog signal;
a digital detection unit, connected to said conduction terminal to produce a digital signal;
an input/output expander, used to expand number of pins of said micro-processor unit;
a storage unit, used to store said test data;
a display unit, used to display said test data; and
wherein said micro-processor unit is connected electrically to said analog detection unit, said digital detection unit, said input/output expander, said storage unit, and said display unit, said micro-processor unit processes said analog signal and said digital signal for outputting said test data.

11. The test device utilizing an electric connector as claimed in claim 9, wherein said connection terminals are terminal holes, and said connection portion extends along bottom of said base vertically downward into shape for inserting into said terminal hole.

12. The test device utilizing an electric connector as claimed in claim 9, wherein an auxiliary piece extends from middle of said contact portion, and said contact portion is made of a spring piece or conductive rubber.

13. The test device utilizing an electric connector as claimed in claim 9, wherein said connection terminals are arranged into various arrays including a polygon array, a circular array, an ellipse array, a sector array, or a bow shape array of 2-dimensional arrangement, and a space exists between adjacent connection terminals.

14. The test device utilizing an electric connector as claimed in claim 13, wherein said polygon array includes a triangle array, a rectangle array, a parallelogram array, a trapezoid array, a rhomb array, a pentagon array, or a hexagon array 2-dimensional arrangement.

15. The test device utilizing an electric connector as claimed in claim 9, wherein said electric connector further includes a first cover, installed over said electric circuit board and said conduction terminals, to form an open slot for said test strip to insert in.

16. The test device utilizing electric connector as claimed in claim 9, wherein said body further includes a containing groove and a second cover, said electric connector is disposed in said containing groove or said second cover, said containing groove is located in a position corresponding to said second cover for containing said test strip.

17. The test device utilizing electric connector as claimed in claim 16, wherein a fixing piece is provided on said containing groove for fixing said test strip.

18. An electric connector manufacturing method, said electric connector is used in a test device, comprising following steps:
(A) arranging a plurality of conduction terminals to align and connect onto at least a folding material belt, one end of a base of each said conduction terminal is connected vertically to said folding material belt, other end of said base extends upward, slanting and bending to form a contact portion, bottom of said base extends vertically downward to form a connection portion;
(B) installing and fixing said folding material belt and said conduction terminals onto a fixture, said base and said contact portion are adjacent closely to an installation surface of said fixture, said connection portion are of a vertical upward shape relative to said installation surface;
(C) placing an electric circuit board having a plurality of terminal holes arranged into an array onto said corresponding fixture, said terminal holes are provided for inserting and bonding said connection portion of each said conduction terminal; and
(D) taking out said electric circuit board, said plurality of conduction terminals, and said folding material belt from said fixture, and detaching said folding material belt, so that said conduction terminals are arranged into an array on said electric circuit board.

19. The electric connector manufacturing method as claimed in claim 18, wherein said folding material belt and said conduction terminals are integrally formed.

20. The electric connector manufacturing method as claimed in claim 19, wherein said fixture further includes at least an installation slot, shape of said installation surface of said fixture corresponds to shape of said conduction terminals.
